(19) United States
(12) Patent Application Publication
(10) Pub. No.: US 2015/0262203 A1
(43) Pub. Date: Sep. 17, 2015

(54) METHOD AND SYSTEM FOR AUTOMATIC SELECTION OF ENERGY SUPPLIER

(71) Applicant: HOMEADE, LLC, Annapolis, MD (US)

(72) Inventors: Ryan PEUSCH, Annapolis, MD (US); Craig TOBE, Wayland, MA (US)

(21) Appl. No.: 14/659,020

(22) Filed: Mar. 16, 2015

Related U.S. Application Data
(60) Provisional application No. 61/953,464, filed on Mar. 14, 2014.

(51) Int. Cl. G06Q 30/02; G06Q 50/06; G06Q 30/04

(52) U.S. Cl. CPC G06Q 30/0201; G06Q 30/04; G06Q 50/06

(57) ABSTRACT

A system and method for automatically selecting an energy supplier includes a database, application servers and task servers in data communication. The task servers include a bill download module to download and parse data associated with a plurality of customer bills and store the parsed data. The application servers include a bill scan module to scan all utility bills, and a monitoring module to process data to ensure customers are charged correctly, and to alert a customer when the monitoring module identifies an inconsistency between the charges and the applicable energy tariff. Application servers also include a supplier rate module to download and store energy tariffs in the database; and a rate logic module to determine a best rate for a customer using data obtained by the bill download module and the bill scan module to obtain bill data and available utility rates.

### CROSS-REFERENCE TO RELATED PATENT APPLICATIONS

This application claims the benefit of and priority to U.S. Provisional Patent Application No. 61/953,464, entitled Automated Electricity and Natural Gas Supplier Selection Software, filed Mar. 14, 2014, and which is hereby incorporated by reference.

### BACKGROUND

The application generally relates to a method and system for automatic selection of energy suppliers. The application relates more specifically to a computer implemented system and method for automated electricity and natural gas supplier selection.

Rate tariffs for electricity and gas supplier can be complex and confusing to energy consumers, in particular residential energy consumers that lack the resources and expertise to make an informed choice. Consumers may have difficulty tracking changes in rates, renewal dates and expiration dates associated with their particular contracts. As a result energy consumers may be confronted with high variable rates when a better tariff is available to them.

Rate tariffs may obfuscate the essential terms of their contract and confuse energy customers as to what they have contracted for. Without the benefit of specialized industry experience an energy consumer may struggle to understand the terms to which he or she has committed. Energy deregulation in some jurisdictions is intended to provide energy customers a competitive market in which to purchase energy. In many of the deregulated jurisdictions consumers may be unable to take advantage of competitive pricing between suppliers due to their inability to understand whether a particular tariff is more beneficial than the consumers' current tariff.

Currently rate aggregators are available, but rate aggregators do not assist consumers in making an educated decision, as the tariffs that are aggregated remain opaque and complex.

Deregulated energy markets may be new to many consumers, so they do not have experience buying electricity or natural gas from suppliers other than a utility.

Consumers currently have to monitor their contract cycle and remember every time a contract expires. There are too many choices and not enough clear and concise ways to make a good decision.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a system for automatically selecting an energy supplier. The system includes a database in data communication with one or more application servers through a data network and a plurality of task servers in data communication with the one or more application servers. The task servers include a bill download module configured to download and parse data associated with a plurality of customer bills and store the parsed data. The application servers include a bill scan module configured to scan all utility bills, and a monitoring module to process data to ensure customers are charged correctly according to an energy tariff and alert a customer associated with the respective energy tariff when the monitoring module identifies an inconsistency between the charges and the applicable energy tariff. Application servers also include a supplier rate module to download and store energy tariffs in the database; and a rate logic module to determine a best rate for a customer using data obtained by the bill download module and the bill scan module to obtain a current and validated customer bill data and a plurality of available utility rates.

Another embodiment relates to a method for automatically selecting an energy supplier. The method includes providing a database in data communication with one or more application servers through a data network; and a plurality of task servers in data communication with the one or more application servers; downloading and parsing data associated with a plurality of customer utility bills; storing the parsed data; scanning all customer utility bills; monitoring customer billing data and ensuring that the respective customers are charged correctly according to an energy tariff and alert a customer associated with the respective energy tariff when the monitoring module identifies an inconsistency between the charges and the applicable energy tariff; downloading and storing a plurality of energy tariffs in the database; and determining a best rate for a customer based on the downloaded data and the scanned bills and obtaining a current and validated customer bill data and a plurality of available utility rates.

In still another embodiment, a method is disclosed for automatically selecting an energy supplier. The method includes aggregating one or more electricity and natural gas rates; selecting a rate based on the lowest tariff of the aggregated one or more electricity and natural gas rates; automatically enrolling a customer in the lowest tariff determined; monitoring a contract based on the enrolled customer tariff; and re-enrolling a customer contract according to a best available energy tariff rate that is available to the customer upon expiration of the customer contract.

The automated selection process constantly determines the best energy rate selection for the consumer. This selection is made to save time and money for the consumer.

Energy supply contracts may be monitored to avoid high temporary variable rates used by suppliers that may take advantage of customers.

The disclosed method and system provides an automated means for selecting a customer's energy tariff for them for the most advantageous tariff that is available. The disclosed method and system makes a difficult and confusing decision easier for the consumer.

Our system is an automated way to have a customer's rate selected for them. This makes a difficult and confusing decision for the consumer easy.

Alternative exemplary embodiments relate to other features and combinations of features as may be generally recited in the claims.

### BRIEF DESCRIPTION OF THE FIGURES

FIG. 1 shows a hardware architecture for an exemplary embodiment of the automatic energy supplier selection system.

FIG. 2 shows the various modules of the automatic energy supplier selection system.

### DETAILED DESCRIPTION OF THE EXEMPLARY EMBODIMENTS

The disclosed invention includes the following components:

1. Rate Aggregation

2. Rate Selection

3. Contract Enrollment

4. Contract Monitoring

5. Contract Re-Enrollment

The Components are related as follows: Under item 1, Rate Aggregation, suppliers' electricity and natural gas rates are aggregated constantly by system 10. For example, a rate calculation for a customer may be triggered by any of the following events: 1.) Customer's bill is downloaded and parsed; 2.) Customer's answers a pertinent question regarding energy usage or life changes; and 3.) New energy rates are retrieved.

Under item 2, Rate Selection, the system 10 selects the best rate determined in Step 1. Under item 3, Contract Enrollment, system 10 enrolls the customer in the rate or tariff determined in Step 2. Under item 4, Contract Monitoring, system 10 monitors the contract in which the customer is enrolled under Step 3. Under item 5, Contract Re-Enrollment, system 10 returns to Step 2 to determine the best rate that is available to the customer upon completion of the customer's contract.

The process stated below is for an individual user's experience. Step 1, Rate Aggregation, requires constant monitoring of available supplier rates in both electricity and natural gas. All available electricity supplier rates as well as utility supply rates must be aggregated. A goal of system 10, at step 1, is to establish a baseline utility rate so that the competitive supplier's rates can be compared to determine the best decision for Step 2. Step 2, Rate Selection, uses the rates established in Step 1 to determine the best choice for the customer. The lowest rate, in $ (USD) per kWh, is selected for the customer. This selection may be made as soon as the customer provides all necessary information for enrollment in a new supplier contract, so that Step 3 may occur. Step 3, Contract Enrollment, uses the rate selected in Step 2 and enrolls the customer in that rate. This enrollment is done using an automated Customer Relationship Management (CRM) program. The customer is notified of their new contract and Step 4 begins. Step 4, Contract Monitoring, begins once the customer is enrolled in a new supplier. The customer's contract expiration is monitored by an automated system. The system starts Step 5 once the contract expiration date approaches. Step 5, Contract Re-Enrollment, returns the process to Step 2 to re-enroll the customer in the best available rate. This process continues as long as the customer is signed up for the service.

The system 10 employs automated software to continuously, or at configurable intervals, determine the best energy rate based on the current energy tariff. The customer uses the product to passively manage their personal energy use and expenditure. Most people currently do not have the ability or understanding of energy tariffs to passively manage their use and expenditures. The system may be configured as software as a service, so that the customer install the application on his or her local device and then the software will be working in the background helping customers save time and money through constant rate and bill monitoring. By contrast, without the software as a service constantly monitoring energy usage and rates for them, a customer may have to repeat a complex process every couple of months to ensure that it was receiving the best option. Generally, the best option is the lowest total price paid for energy over a contract period or other defined period of time, and is typically not determined on a per bill basis.

Additionally: the system can be used to select the best possible product between equal options at different price points. This arbitrage opportunity exists in many different markets.

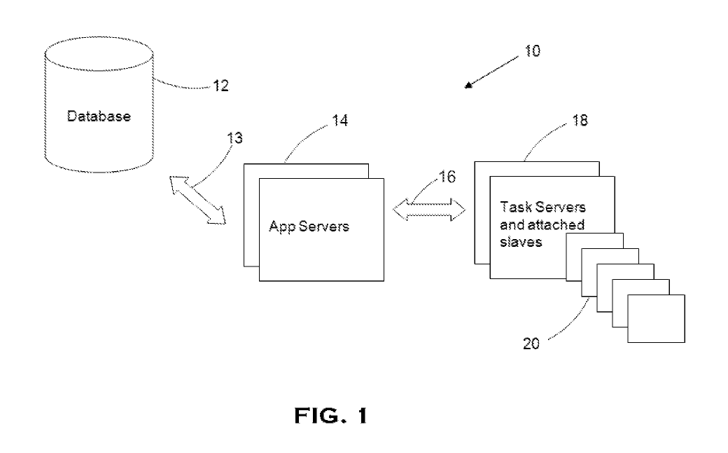

FIG. 1 shows a hardware architecture for an exemplary embodiment of the automatic energy supplier selection system 10. AESS system 10 includes a database 12 in data communication 13 with one or more application servers 14. Application servers 14 communicate through a data network 16 with task servers. The hardware architecture for the automatic energy supplier selection system 10 may include many other features that are not shown in FIG. 1. These features have been purposely omitted to simplify the drawing for ease of illustration.

Task servers 18 include a bill download module 100. Bill download module 100 provides several functions, including but not limited to, downloading and parsing customer bills and storing the parsed data associated with the customer bills. The following describes one exemplary embodiment of a bill download process as it may be executed by the bill download module 100. First, task server 18 accesses and downloads customer bills utilizing a continuous integration software server to manage various nodes, e.g., slave computers 20 and activities, e.g., jobs. In one embodiment the continuous integration software server may be an extensible open source continuous integration server such as Jenkins, although other similarly functional continuous integration servers may be employed.

Next, one or more of the jobs on task server 18 downloads customer energy bills using automation code. Download jobs may run sequentially or simultaneously. The bill download module 100 may be arranged to download jobs at predetermined intervals, e.g., download jobs may be run daily, weekly, monthly, or on demand. Bill download module 100 may use Selenium IDE, a Firefox browser add-on that allows recording, editing, and debugging tests, or other similar automated browser simulation, to access a utility or energy supplier website, login as a user, and download all bills or the bills that have not previously been downloaded.

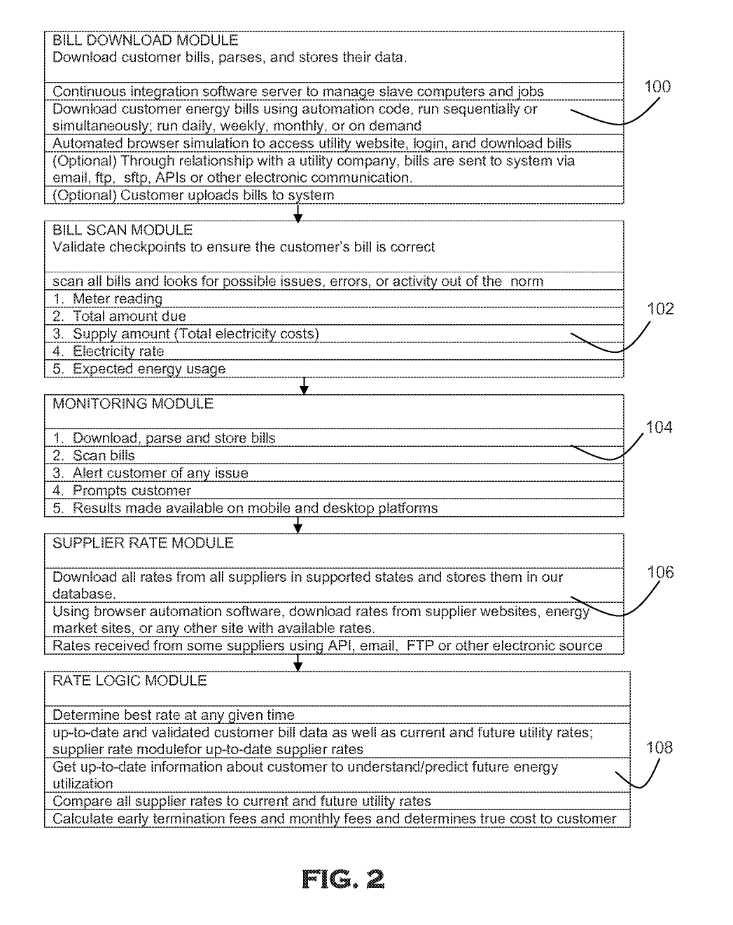

Referring next to FIG. 2, in an alternate embodiment, bill download module 100 may process the bill downloads directly, upon establishing a relationship with a utility company. Customers' bills may be sent directly to bill download module 100 through email, ftp, sftp, APIs or any other electronic form of communication.

In yet another embodiment, bill download module 100 may process bill downloads as follows. i. The customer uploads their bills to bill download module 100. Customer provided bills are then parsed and stored in database 12 via an API call to application servers 14. Current and future utility rates may also be parsed from these bills and stored for later use by a rate logic module as disclosed below.

App Server 14 includes a bill scan module 102. Bill scan module 102 is configured to scan all utility bills and looks for possible issues, errors, or activity out of the norm. Bill scan module 102 validates numerous checkpoints to ensure the customer's bill is correct using bill scan logic, as follows.

Meter reading information is checked to verify that the meter reading is accurate and is consistent with the kilowatt hours (KWH) charged to the associated consumer account being billed.

Next, the total amount due is verified to be equal to the “total distribution costs”, plus “total transmission costs”, plus “previous balance”, plus the “supply amount (electricity costs)”, plus the “miscellaneous taxes and fees”, as set forth in the applicable tariff.

The supply amount, or total electricity costs, is verified by the bill scan module 102, to verify that is equal to the “KWH used” “energy rate”, or mcf in the case of gas usage.

The electricity rate is verified by the bill scan module 102, to ensure that the charges are correctly determined according to the tariff stored in database 12 for the respective consumer.

In addition, the bill scan module 102 determines the expected energy usage by, e.g., comparing the applicable tariff to previous months and years for that customer, taking into account weather and seasonal data, as well as data provided by the consumer about possible life or home changes. The bill scan module 102, determines if the energy utilization is within a predetermined range, e.g., a range that is acceptable to the customer.

App server 14 additionally includes a monitoring module 104. Monitoring module 104 processes billing data to ensure customers are charged correctly according to the applicable energy tariff. Monitoring module 104 alerts customers when the module 104 identifies an inconsistency between the charges on the bill and the applicable tariff. Bills are downloaded, parsed, and stored in database 12 with Bill Download Module 104. The system 10 scans the bills after downloading for any issues using bill scan module 102. Monitoring module 104 alerts customer of any issue.

The system may include prompts to customers with questions to better understand any large changes in their energy utilization. To account for changes in personal lifestyles, the rate logic employed by the system always applies the latest available information about a customer. Rate logic is discussed below with respect to the rate logic module. This information may be acquired through simple questions answered by the customer on an application or website or by monitoring the customers' bills. Changes like addition of a swimming pool, additional family members or roommates residing in the home, employment, solar or geothermal installations, etc., may have an impact on a customer's energy utilization.

Monitoring and bill scan results may be made available to the customer on either a mobile or desktop platforms.

Application Servers 14 also include a supplier rate module 106. Supplier rate module 106 downloads all of the tariffs or rate schedules available from all suppliers in the associated jurisdiction, or state, and stores the tariffs in database 12. There are various ways that supplier rate module 106 may operate.

In one embodiment, supplier rate module 106 employs “jobs” similar to those defined in bill download module 100 to use browser automation to download rates from supplier websites, energy market sites, or any other site with available rates. These rates are then parsed, sanity tested, and stored in our database.

In another embodiment, supplier rate module 106, after establishing relationships with energy suppliers, tariffs or rates may be sent directly to system 10 by energy suppliers that are configured to use the system application program interface (AP)I, email, FTP or any other electronic source where information can be read and parsed.

App Servers 14 further include a rate logic module 108. Rate logic module 108 determines the best rate for a customer at any given time. Our rate logic process is as follows. Rate logic module 108 utilizes bill download module 108 and bill scan module 108 to obtain current and validated customer bill data as well as current and future utility rates. Rate logic module 108 utilizes the supplier rate module to obtain current supplier rates. Rate logic module 108 utilizes monitoring module 104 obtain current data about the respective customers to better analyze and predict future energy utilization. In one embodiment future energy predictions may be based on trending patterns. Alternately predictions may override trending patterns. For example, a spike in energy utilization may be permanent or temporary. If permanent, the algorithm may ignore past energy usage or increase the energy usage predictions by a factor of X with X being the percentage increase. If temporary, the algorithm may omit that month from our calculations when looking for a new energy plan and treat it as an outlier.

Rate logic takes the following factors into consideration on a per customer basis and will rank the best suppliers and rates for a given customer:

Rate logic module 108 compares all supplier rates to current and future utility rates. Rate logic module 108 also calculates early termination fees and monthly fees and determines true cost to customer. True cost takes into account more than just the energy rate. True cost also considers penalties paid for switching energy suppliers, and monthly fees that may be associated with a new rate.

One example of a rate logic comparison is described below:

Rate logic module 108 determines the total cost to the customer associated with switching to a new tariff or rate schedule, including early termination fees and monthly fees (ETF=early termination fee∥cur=current)

The exemplary algorithm executed by rate logic module 108 is:

newContractFees=(newContractMonthlyFee*newContractTerm)+newContractInitialFee [EQ. 1]

switchPenalty=curContractETFFixed+(curETFMonthly*curContractMonthsRemain) [EQ. 2]

totalSwitchCost=newContractFees+switchPenalty [EQ. 3]

totalPlanEstimatedCosts=(newSupplierRate*CustomerExpectedKwUsageForNewContactTerm)−totalSwitchCost [EQ. 4]

The totalPlanEstimatedCosts is then compared across all plans to determine the best rate for the customer.

Using market prediction data, system 10 then calculates whether the variable rate will go up or down. Market prediction data may be obtained from a 3^{rd} party service that provides such data. Alternately, the market prediction data may be based upon known energy rate scheduled increases (or decreases), and the wholesale prices that suppliers pay for energy, which are commonly published a year in advance. If variable rates may trend up, the system may assume the high point, or worst case, when performing calculations.

d. Contract optimizer or “sweet spot” tool. A contract sweet spot tool applies existing market data and tells us the best choice for contract length. Common contract lengths, or terms, may be, e.g., 3, 6, 12, and 24 months. However, an 8 month contract term may provide a much cheaper rate for the customer. As long as rates aren't predicted to be higher after that 8 month period (or whatever the contract optimizer tool recommends, rates from suppliers that match the optimized rate will be highly favored since they will have a lower rate.

It should be understood that the application is not limited to the details or methodology set forth in the following description or illustrated in the figures. It should also be understood that the phraseology and terminology employed herein is for the purpose of description only and should not be regarded as limiting.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

As noted above, embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A system for automatically selecting an energy supplier comprising:
a database in data communication with one or more application servers through a data network; and a plurality of task servers in data communication with the one or more application servers;
the plurality of task servers comprising a bill download module configured to download and parse data associated with a plurality of customer bills and store the parsed data
the one or more application servers comprising:
a bill scan module configured to scan all utility bills
a monitoring module configured to process data to ensure customers are charged correctly according to an energy tariff and alert a customer associated with the respective energy tariff when the monitoring module identifies an inconsistency between the charges and the applicable energy tariff;
a supplier rate module configured to download and store a plurality of energy tariffs in the database; and
a rate logic module configured to determines a best rate for a customer using data obtained by the bill download module and the bill scan module to obtain a current and validated customer bill data and a plurality of available utility rates.

2. The system of claim 1, wherein the rate logic module is configured to compare the stored supplier rates to current and future utility rates, calculates an early termination fee and monthly fee and determines actual or true cost to the respective customer.

3. The system of claim 2, wherein the rate logic module is further configured to obtain one or more current supplier rates the from the supplier rate module; and obtain data about the respective customers to analyze and predict a future energy utilization associated with the customer.

4. The system of claim 1, wherein the plurality of task servers accesses and downloads customer bills utilizing a continuous integration software server to manage a plurality of nodes.

5. The system of claim 4, wherein the continuous integration software server may be an extensible open source continuous integration server such as Jenkins, although other similarly functional continuous integration servers may be employed.

6. The system of claim 1, wherein the bill scan module examines energy bills for possible issues, errors, or activity out of a norm; and validates numerous checkpoints to ensure that a customer's bill is correct.

7. The system of claim 1, wherein the bill download module processes the bill downloads directly from a utility company upon establishing a relationship with the utility company, wherein customers' bills are sent directly to the bill download module via electronic communications, email, ftp, sftp, or APIs.

8. The system of claim 2, wherein the rate logic module determines a total cost associated with switching a tariff by applying an algorithm executed by rate logic module comprising:
newContractFees=(newContractMonthlyFee*newContractTerm)+newContractInitialFee
switchPenalty=curContractETFFixed+(curETFMonthly*curContractMonthsRemain)
totalSwitchCost=newContractFees+switchPenalty
totalPlanEstimatedCosts=(newSupplierRate*CustomerExpectedKwUsageForNewContactTerm)−totalSwitchCost; and
the totalPlanEstimatedCosts is then compared across all plans to determine the best rate for the customer.

9. The system of claim 1, wherein a customer uploads an energy bill associated with a respective account, to the bill download module, and the energy bill is parsed and stored in the database via an API call to the application server, and wherein a current and a future utility rate is parsed from the respective customer energy bill and stored for use by the rate logic module.

10. The system of claim 1, wherein a meter reading is automatically verified for accuracy as consistent with an amount of kilowatt hours (KWH) that is charged to the associated customer account.

11. The system of claim 10, wherein a total amount due is equal to a total distribution cost, plus a total transmission cost, plus a previous balance, plus a supply amount, plus a miscellaneous taxes and fee.

12. The system of claim 1, wherein an electricity rate is verified by the bill scan module to determine that the charges are correct according to the applicable tariff stored in the database and associated with the respective customer.

13. The system of claim 1, wherein the bill scan module is configured to determine an expected energy usage by comparing the energy tariff to previous customer bills from previous months and years, and to take into account weather and seasonal data, and data provided by the customer related to life or home changes; and to determine if an energy utilization for the customer is within a predetermined range.

14. The system of claim 1, wherein the bill scan module is configured to compare the applicable energy tariff to previous monthly bills and yearly bills for the respective customer based upon local weather data and seasonal data, and customer data provided by the customer about customer energy use changes.

15. A method for automatically selecting an energy supplier comprising:
providing a database in data communication with one or more application servers through a data network; and a plurality of task servers in data communication with the one or more application servers;
downloading and parsing data associated with a plurality of customer utility bills;
storing the parsed data;
scanning all customer utility bills;
monitoring customer billing data and ensuring that the respective customers are charged correctly according to an energy tariff and alert a customer associated with the respective energy tariff when the monitoring module identifies an inconsistency between the charges and the applicable energy tariff;
downloading and storing a plurality of energy tariffs in the database; and
determining a best rate for a customer based on the downloaded data and the scanned bills
and obtaining a current and validated customer bill data and a plurality of available utility rates.

16. The system of claim 15, wherein a result of the monitoring module and the bill scan module is made available to the customer on a mobile or a desktop platform.

17. The method of claim 15, wherein determining a best rate comprises comparing the applicable energy tariff to previous monthly bills and yearly bills for the respective customer by taking into account weather and seasonal data, and customer data provided by the customer about customer changes.

18. The system of claim 15, further comprising determining via the bill scan module an expected energy usage by comparing the energy tariff to previous customer bills from previous months and years, and by taking into account weather and seasonal data, and data provided by the customer related to life or home changes; and determining if an energy utilization for the customer is within ad predetermined range.

19. The system of claim 15, further comprising alerting a customer in response to identifying an inconsistency between the charges on the bill and the energy tariff.

20. A method for automatically selecting an energy supplier comprising:
aggregating one or more electricity and natural gas rates;
selecting a rate based on the lowest tariff of the aggregated one or more electricity and natural gas rates;
automatically enrolling a customer in the lowest tariff determined;
monitoring a contract based on the enrolled customer tariff;
re-enrolling a customer contract according to a best available energy tariff rate that is available to the customer upon expiration of the customer contract.
